(19) United States
(12) Patent Application Publication
(10) Pub. No.: US 2004/0056851 A1
(43) Pub. Date: Mar. 25, 2004

(54) Variable drive controller for image sensing systems

(75) Inventors: Edward P. Lawler, Fairport, NY (US); David Charneski, Hilton, NY (US); Wayne W. Hintz, Bergen, NY (US); John T. Compton, Leroy, NY (US); Herbert J. Erhardt, Webster, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/340,486

(22) Filed: Jan. 10, 2003

Related U.S. Application Data
(60) Provisional application No. 60/412,538, filed on Sep. 20, 2002.

(51) Int. Cl. G09G 5/00

(52) U.S. Cl. 345/204

(57) ABSTRACT

A timing generator for controlling an image sensor, the timing generator includes a first output driver that is continuously supplying a current to an output; a second output driver that is connected in parallel with the first output driver and that is selectively energized for supplying an additional current to the output; a controller that is electrically connected to the second driver which, based on the resulting waveform at the output, is adjusted to either supply its current or not supply its current for varying a total current to the output to control an image sensor.

### CROSS-REFERENCE TO RELATED APPLICATIONS

This is a 111A application of Provisional Application Serial No. 60/412,538, filed Sep. 20, 2002.

### FIELD OF THE INVENTION

This invention relates generally to timing generators for electronic imaging systems and, more particularly, to such timing generators which have adjustable drive strength outputs for controlling electrical noise in such systems.

### BACKGROUND OF THE INVENTION

Electrical noise is known to degrade image quality in electronic imaging systems, especially in timing generator circuits which control image sensors. Unfortunately, as such systems move to higher clock speeds the overall system noise tends to increase.

One contributing factor in electrical noise is the rise and fall time associated with electrical signals. A traditional integrated circuit is designed to provide sufficient drive capacity to operate its outputs at the highest specified clock speed. If the device is operated at a lower clock speed, the same rise and fall times are still produced, even though they are not necessary to circuit function. This is undesirable because it produces noise that is not necessary and can be avoided by lengthening the rise and fall times.

Although the presently known and utilized systems are satisfactory, they include the above-described drawbacks. Consequently, a need exists for a timing generator which eliminates these drawbacks.

### SUMMARY OF THE INVENTION

The present invention is directed to overcoming one or more of the problems set forth above. Briefly summarized, according to one aspect of the present invention, the invention resides in a timing generator for controlling an image sensor, the timing generator includes a first output driver that is continuously supplying a current to an output; a second output driver that is connected in parallel with the first output driver and that is selectively energized for supplying an additional current to the output; and a controller that is electrically connected to the second driver which, based on the resulting waveform at the output, is adjusted to either supply its current or not supply its current for varying a total current to the output to control an image sensor.

These and other aspects, objects, features and advantages of the present invention will be more clearly understood and appreciated from a review of the following detailed description of the preferred embodiments and appended claims, and by reference to the accompanying drawing.

### ADVANTAGEOUS EFFECT OF THE INVENTION

The present invention has the advantage of allowing the drive strength to be adjusted to the minimum required for the specific application thereby reducing noise and providing the best image quality.

### BRIEF DESCRIPTION OF THE DRAWINGS

FIG. 1 is a block diagram of the timing generator of the present invention.

### DETAILED DESCRIPTION OF THE INVENTION

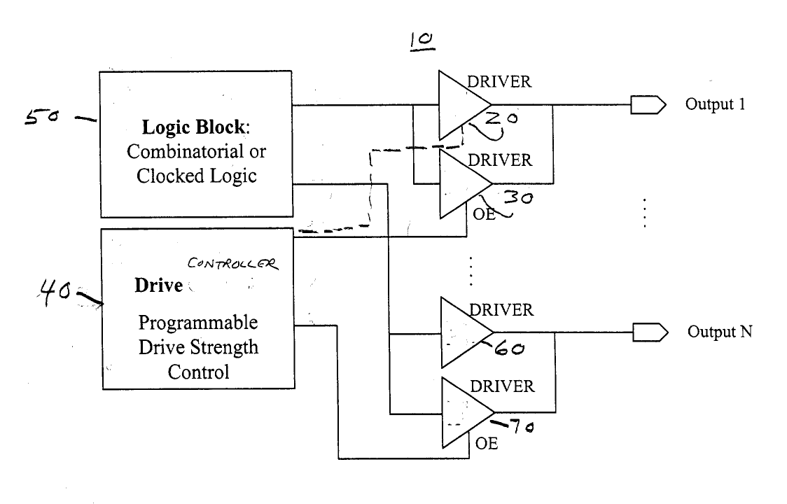

Referring to FIG. 1, there is shown the timing generator 10 of the present invention. The timing generator 10 supplies current to various circuitry of an image sensor system (not shown). For clarity of understanding, only one output to the sensor system is discussed in this paragraph and multiple outputs are discussed hereinbelow. In regard to one output, the timing generator 10 includes an output driver 20, which supplies continuous current to an output. A second driver 30 is connected in parallel to the first driver 20, and is selectively energized for supplying an additional current to the output. A drive controller 40 is electrically connected to the second driver 30 which, based on the resulting waveform at the output, is adjusted to either supply its current or not supply its current for varying a total current to the output to control an image sensor.

Alternatively, the drive controller 40 can be electrically connected to the first driver 20, as shown by the dashed line. Based on the resulting waveform at an output, both drivers 20 and 30 are individually adjustable to either supply their respective current or not supply their respective current for varying a total current to the output to control an image sensor.

It is instructive to note that, in both the preferred and alternative embodiment, additional drivers in addition to the first and second drivers 20 and 30 may be added in parallel for varying the output strength over a wider range and with more gradations.

As shown in the drawing, the drive strength of each output, 1 to N, is independently controlled by enabling or disabling parallel drivers. Logic block 50 generates the logic state for the drivers which, in turn, determine the outputs, 1 to N. A single driver for each output (for example, drivers 20 and 60) is always enabled, and provides the minimum amount of drive strength. Drive controller 40 enables or disables a parallel driver assigned to each output (for example, drivers 30 and 70). When these drivers 30 and 70 are enabled, the drive strength of each output is increased. For example, for output 1 if driver 30 is enabled the drive strength is the sum of drivers 20 and 30. Additional drivers (not shown) for each output can be added in parallel. This allows additional drive strength and/or finer resolution of drive strength. Also the drivers for each output could have unique drive strengths, providing some outputs with more or less drive strength, and/or more or less resolution.

The invention has been described with reference to a preferred embodiment. However, it will be appreciated that variations and modifications can be effected by a person of ordinary skill in the art without departing from the scope of the invention.

### Parts List

10 timing generator

20 first driver for output 1

30 second driver for output 1

40 drive controller

50 logic block

60 first driver for output N

70 second driver for output N

1. A timing generator for controlling an image sensor, the timing generator comprising:
(a) a first output driver that is continuously supplying a current to an output;
(b) a second output driver that is connected in parallel with the first output driver and that is selectively energized for supplying an additional current to the output;
(c) a controller that is electrically connected to the second driver which, based on the resulting waveform at the output, is adjusted to either supply its current or not supply its current for varying a total current to the output to control an image sensor.

2. A timing generator for controlling an image sensor, the timing generator comprising:
(a) a first output driver that is selectively energized for supplying a current to an output;
(b) a second output driver that is connected in parallel with the first output driver and that is selectively energized for supplying an additional current to the output;
(c) a controller that is electrically connected to the first and second drivers which, based on the resulting waveform at an output, are both individually adjustable to either supply their respective current or not supply their respective current for varying a total current to the output to control an image sensor.

3. The timing generator as in claim 1, wherein the first and second drivers are adjusted for matching specific drive strength required for the output.
